(19) United States
(12) Patent Application Publication
(10) Pub. No.: US 2011/0027601 A1
(43) Pub. Date: Feb. 3, 2011

(54) WATER BASED BARRIER COATING COMPOSITIONS

(75) Inventors: Charles G. Ruffner, JR., Cary, NC (US); David E. Knox, Apex, NC (US); Julie A. Willoughby, Cary, NC (US)

Correspondence Address: MEADWESTVACO CORPORATION;ATTN: IP LEGAL DEPARTMENT, 1021 MAIN CAMPUS DRIVE, RALEIGH, NC, 27606, US

(73) Assignee: MEADWESTVACO CORPORATION, Richmond, VA (US)

(21) Appl. No.: 12/935,298

(22) PCT Filed: Mar. 11, 2009
(86) PCT No.: PCT/US09/36791

§ 371 Date: Sep. 29, 2010

Related U.S. Application Data
(60) Provisional application No. 61/049,252, filed on Apr. 30, 2008.

(51) Int. Cl. B32B 27/08; C08K 3/34; C08K 3/26; C08K 3/22; C08K 3/30; B32B 27/32; C08L 77/00; C08L 27/06; C08L 29/04; C08L 55/00

(52) U.S. Cl. 428/515; 524/447; 524/451; 524/445; 524/425; 524/432; 524/423; 428/523; 428/500; 524/570; 524/606; 524/567; 524/543; 524/565

(57) ABSTRACT

A water-based barrier coating composition is disclosed that has improved barrier performance and enhanced stability. The water-based coating composition comprises a polymeric binder and an amine stabilizer, wherein the pH of the composition is equal to or greater than the pKa of the amine stabilizer. When desired, the disclosed coating composition may further include standard low-cost fillers, layered fillers capable of being at least partially exfoliated, nanoparticle fillers, or mixtures thereof. A multilayer product comprising a layer of the disclosed water-based coating composition is also disclosed that has enhanced oxygen barrier performance.

This non-provisional application relies on the filing date of provisional U.S. Application Ser. No. 61/049,252 filed on Apr. 30, 2008, having been filed within twelve (12) months thereof, which is incorporated herein by reference, and priority thereto is claimed under 35 USC §1.19(e).

### BACKGROUND OF THE DISCLOSURE

Barrier coatings which prevent or reduce the permeation of a selected substrate such as gas, vapor, liquid and/or aroma are widely used in the packaging, automobiles, paints, and tire industries. Resistance to the permeability of gases such as oxygen is useful in packaging of sensitive foods, drugs and chemicals. It is known that the barrier properties of a polymer can be improved by addition of exfoliated, layered fillers. It is further recognized that the orientation of the layered fillers in the polymeric binder is critical to achieve enhanced barrier properties. When the layered fillers are exfoliated and oriented perpendicular to the diffusion direction (i.e., parallel to the plane of the polymeric material), there is tortuous effect wherein diffusing molecules must go around the layered fillers. This lowers the diffusion rate through the polymeric structure, resulting in a significant reduction in the composite permeability.

Several techniques have been reported for the preparation of a barrier coating composition containing exfoliated layered fillers. The barrier composition may be obtained by post-add process, wherein the exfoliated layered fillers are mixed into the pre-formed polymeric binder. Alternatively, the barrier composition may be obtained by mixing the exfoliated layered fillers with monomers, followed by polymerization of the monomers to form a polymer containing dispersed layered fillers. The process is known as in-situ polymerization process and is described in U.S. Pat. No. 6,759,463.

The barrier composition may be prepared as a molten compound or in a liquid carrier. When the barrier composition is produced in a molten state, the layered fillers are mixed into the molten polymeric binder or monomeric precursors of the polymer. In addition to the perpendicular orientation of the layered fillers in the polymeric binder upon film forming, the compatibility of the two components is crucial in achieving excellent barrier performance. U.S. Pat. No. 4,528,235 discloses a thin barrier film containing high density polyethylene and small-sized layered fillers that are homogeneously distributed throughout the film and substantially parallel to the plane of the film. To improve its compatibility with the polymer, the filler is coated with amino silane coupling agents such as γ-aminopropyltriethoxy-silane. To orient the layered fillers substantially in parallel to the plane of the polymeric film, the film made of melt-blended polymer and layered fillers is biaxially stretched. Barrier coatings made from melt processing generally contain less than 3% by weight of the layered fillers and as a result, such coatings do not optimally reduce permeability. Moreover, these barrier coatings are commonly applied to the substrate by a multiply extrusion process, which leads to a high production cost.

When a barrier composition is produced, water is the best alternative due to its environmental concerns compared to organic solvents. Several factors must be taken into consideration for attaining water-based barrier coating compositions. First, the layered fillers must be exfoliated and oriented such that upon applying the composition onto the substrate and drying, the layered fillers are perpendicular to the diffusion direction. Second, the layered fillers must be compatible with the polymeric binder. Third, the water-based coating composition must have excellent stability over time, as well as when being processed to coat the substrate.

To achieve enhanced barrier performance, the layered fillers in the aqueous medium should be exfoliated to the greatest extent possible. Typically, the layered fillers are pre-treated with an ionic solution to exchange the naturally occurring interlayer cations (e.g., Na⁺, K⁺) of the layered fillers with the cations in the solution, resulting in exfoliation of the layered fillers in the aqueous media. Acid solution (i.e., “acid-wash”) is commonly used for a pretreatment of layered fillers. U.S. Pat. No. 7,119,138 describes a water-based barrier coating composition containing a polymeric elastomer binder and layered silicate fillers, wherein the silicates are pre-treated with acid or base to provide dispersed, substantially exfoliated silicate fillers. Acid washing of very thin clays is also divulged in U.S. Pat. No. 6,107,387 for coatings having a cationic exchange capacity of 30 to 200 milliequivalents per 100 grams of the clay; montmorillonite is included in the claims of this patent. U.S. Pat. No. 7,473,729 also describes an acid treated clay system which is combined with a non-elastomeric acrylic polymer. U.S. Pat. No. 4,425,465 discloses a water-based coating composition, comprising a dispersion of exfoliated vermiculite particles in an aqueous solution or dispersion of a film-forming polymeric binder. The vermiculite is pre-treated with one or more aqueous solutions of alkali metal salts or alkyl ammonium salts, and then milled to delaminate the vermiculite into lamellae structure. These coating compositions, however, usually require a stabilizing surface active agent to inhibit flocculation of one or more of the components in the compositions.

To enhance the compatibility between the layered filler and the polymeric binder, the layered fillers are generally pre-treated with a surface-modified agent to render the fillers less hydrophobic. Examples of such modifying agents are amino acid, surfactant containing alkylammonium ion groups, and the like. In an acidic medium where the pH of that medium is lower than the pKa of the amino acid, the amine functionality on the amino acid is protonated to an ammonium salt that can cationic exchange with the naturally occurring interlayer cations of the layered fillers. It is believe that alkylammonium ion surfactant also readily exchange with the naturally occurring interlayer cations of the layered fillers. One drawback of using these modifying agents is that the ammonium-based ion destabilizes the water-based coating composition whenever the pH of the combined dispersion is less than the pKa of the acid group on the polymer backbone. In fact, these compositions would only be stable for relatively short periods of time and would tend to precipitate due to protonation of the carboxylate groups on the polymer backbone.

Several approaches have been reported for improving the stability of the water-based coating composition containing exfoliated layered fillers. U.S. Pat. No. 6,087,016 describes a water-based barrier coating composition, containing a polymeric elastomer binder, dispersed exfoliated layered fillers having an aspect ratio greater than 25, and at least one surfactant. A non-ionic compound is preferred as the surfactant. It is reported that any additional ionic surfactants or ionic additives must be kept to a minimum. Increase in ionic concentration in the water-based composition, such as by the addition of an ammonium hydroxide base to adjust pH, causes agglomeration of the fillers, which adversely affects the barrier performance and dramatically decreases the composition stability. In U.S. Pat. No. 6,107,387 (also cited above) a water-based barrier coating composition containing exfoliated layered fillers is disclosed that is stable upon standing at ambient conditions of temperature and pressure and does not flocculate or form hard sediment. The layered fillers are pre-treated with acid and the exfoliated fillers are stabilized via intercalation with a cationic group-containing polymer or polymer having functional groups that can be post-reacted to form a cationic group.

In order to obtain a water-based coating composition with excellent barrier performance and stability, several aforementioned factors must be taken into consideration in addition to its cost, environmental impact, and health concerns.

U.S. Pat. No. 7,452,573 discloses a method of making a substrate having oxygen barrier properties. A blend of a water solution or dispersion of an oxygen barrier material and calcium carbonate nanoparticles is prepared and coated onto the substrate. To achieve the desired oxygen barrier performance, the size of calcium carbonate particles must be in the nanometer range of 10 to 250 nanometers. Unfortunately, nanoparticles are rather expensive and in the case of calcium carbonate (CaCO₃), the pH of the coating would be limited to generally greater than pH of 7 due to the decomposition of CaCO₃. Furthermore, there have been increasing health concerns on the handling and use of nanoparticles.

Accordingly, there remains a need for water-based barrier coating compositions with enhanced stability and barrier performance that are economical, environmental-friendly, and easy to handle.

When paperboard is used as a substrate, water-based barrier coating compositions have usually been applied after the paperboard is formed rather on-line during the papermaking process. This is typically because the coating cannot withstand the harsh conditions of the papermaking process. This results in high production and handling costs. Furthermore, the water-based barrier coating composition must have excellent film-forming properties to provide a continuous coating on the surface of substrate, which is required for excellent barrier performance.

Therefore, it is highly desirable to have a water-based barrier coating that may be applied onto the substrate on-line during the paper-making process to lower the production and handling costs.

### SUMMARY OF THE DISCLOSURE

A water-based barrier coating composition is disclosed that has improved barrier performance and enhanced stability. The water-based coating composition comprises a polymeric binder and an amine stabilizer, wherein the pH of the composition is equal to or greater than the pKa of the amine stabilizer. When desired, the disclosed coating composition may further include standard low-cost fillers, layered fillers capable of being at least partially exfoliated, nanoparticle fillers, or mixtures thereof. A multilayer product comprising a layer of the disclosed water-based coating composition is also disclosed that has enhanced oxygen barrier performance.

### BRIEF DESCRIPTION OF THE DRAWINGS

FIG. 1 shows one embodiment of the disclosed multilayer product, comprising a substrate and a layer of the disclosed water-based barrier coating composition applied on one surface of the substrate;

FIG. 2 shows one embodiment of the disclosed multilayer product, comprising a substrate and layers of the disclosed water-based barrier coating composition applied on both surfaces of the substrate;

FIG. 3 shows one embodiment of the disclosed multilayer product, comprising a substrate, a layer of the disclosed water-based barrier coating composition applied on one surface of the substrate, and a sealing layer on the other side of the substrate;

FIG. 4 shows one embodiment of the disclosed multilayer product, comprising a substrate, a layer of the disclosed water-based barrier coating composition applied on one surface of the substrate, and a functional layer on the other side of the substrate;

FIG. 5 shows one embodiment of the disclosed multilayer product, comprising a substrate, a layer of polymeric film, and a layer of the disclosed water-based barrier coating composition between the substrate layer and the polymeric film;

FIG. 6 shows one embodiment of the disclosed multilayer product, comprising a substrate, a layer of the disclosed water-based barrier coating composition applied on one surface of the substrate, a layer of polymeric film on the other side of the substrate, and a layer of polymeric film at the outer surface of the barrier coating layer;

FIG. 7 shows one embodiment of the disclosed multilayer product, comprising a substrate, a layer of basecoat on one surface of the substrate, and a layer of the disclosed water-based barrier coating composition above the basecoat layer; and

FIG. 8 shows one embodiment of the disclosed multilayer product, comprising a multilayer structure of FIG. 7, and layers of polymeric film on both sides of its surface.

### DESCRIPTION OF THE DISCLOSURE

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

The disclosed water-based barrier coating composition comprises:
(a) a polymeric binder; and
(b) an amine stabilizer, wherein pH of the water-based composition is greater or equal to the pKa of the amine stabilizer.

In one embodiment of the present disclosure, the water-based barrier coating composition comprises:
(a) a polymeric binder;
(b) filler particle; and
(c) an amine stabilizer, wherein pH of the water-based composition is greater or equal to the pKa of the amine stabilizer.

The fillers suitable for use in the present disclosure may be layered particles capable of being at least partially exfoliated or intercalated, standard low-cost filler particles where intercalation may not occur, or mixtures thereof. When desired, the filler particle may have a particle size in nanometer range. However, it is not required that the filler particles be layered fillers or nanoparticle fillers in order for the disclosed water-based barrier coating to have excellent barrier performance. A wide range of standard low-cost filler particles used in the typical paper coating may be applied in the present disclosure. Examples of such standard low-cost fillers include, but are not limited to, kaolin clay, talc, calcined clay, structured clay, ground calcium carbonate, precipitated calcium carbonate, titanium dioxide, aluminum trihydrate, satin white, silica, zinc oxide, barium sulfate, and mixtures thereof. When desired, the fillers capable of imparting anti-blocking properties to the coating composition may be used. Examples of the suitable layered fillers include, but are not limited to, bentonite, vermiculite, montmorillonite, montronite, beidellite, smectite, kaoline, kaolinite, halloysite, phyllosilicate, synthetic phyllosilicates, volkonskoite, hectorite, saponite, illite, laponite, sauconite, magadiite, kenyaite, ledikite, sobockite, stevensite, svinfordite, dickite, nacrite, antigorite, chrysotile, pyrophyllite, tetrasilylic mica, sodium teniolite, muscovite, margarite, phlogopite, xanthophyllite, talc, ground mica, platelet silicas, flaked metal, flaked glass, chlorite, and combinations thereof. Examples of chlorites are clinochlore, chamosite, nimite, and pennantite.

It is unexpected that the disclosed water-based coating composition has excellent barrier performance even when absence of layered filler particles or nanoparticle fillers. In order to achieve enhanced barrier performance, however, it is critical that the pH of the disclosed water-based composition be greater or equal to pKa of the amine stabilizer.

It is well-recognized that generally the layered fillers in the barrier coating compositions must be pre-treated (e.g., acid washed) to promote exfoliation, enhance compatibility with the polymeric binders, and improve stability. Unexpectedly, the water-based barrier coating composition of the present disclosure exhibits excellent stability and enhanced barrier performance without the need for an initial acid wash of the layered fillers. Moreover, the pH of the disclosed water-based barrier coating composition must be equal to or greater than the pKa of the amine stabilizer. One skilled in the art will not expect such results, since it is a well-established practice as discussed earlier that the layered fillers in the water-based barrier coating must be pre-treated to allow the exfoliation through cationic exchange of the naturally occurring interlayer cations of the layered fillers with the cations of the pre-treating agent, such as hydronium ion from the acidic solution in “acid wash” process, alkylammomium ions from the alkylammomium ion-containing surfactant, or alkylammomium ions from the amino acid in acidic medium. On the contrary, the water-based barrier coating composition of the present disclosure has pH of equal to or greater than the pKa of the amine stabilizer. Therefore, the amine stabilizer in the disclosed composition will not be present in the form containing alkylammomium ions that provide for exfoliation of the layered fillers. This unexpected result may be because the amine stabilizer in the disclosed composition promotes the interlaminar exfoliation of layered fillers through a process other than the known cationic exchange reaction or somehow interacts with the filler as the standard low-cost, non-layered fillers also show beneficial results.

The binder refers to any material that provides cohesive strength to the coating. The polymeric binder suitable for use in the present disclosure may be elastomeric polymers or non-elastomeric polymers. Additionally, the polymeric binder may be a synthetic polymer or a natural polymer. In one embodiment of the present disclosure, the polymeric binder includes a polymer selected from the group consisting of polyesters, styrene-acrylic polymers, styrene-butadiene polymers, vinyl-acrylic polymers, polyvinyl acetate, polyurethanes, and combinations thereof. In one embodiment of the present disclosure, the polymeric binder is derived from ethylenically unsaturated monomers. In one embodiment of the present disclosure, the polymeric binder is derived from monomers selected from the group consisting of C₁-C₁₈ alkyl methacrylate, C₁-C₁₈ alkyl acrylate, 2-ethylhexyl(meth)acrylate, isobornyl(meth)acrylate, lauryl(meth)acrylate, allyl (meth)acrylate, stearyl(meth)acrylate, acrylic acid, itaconic acid, methacrylic acid, butadiene, vinyl acetate, vinyl versatate, ethylene, styrene, vinyl aromatic monomers, vinyl acrylic monomers, hydroxyethyl(meth)acrylate, hydroxypropyl(meth)acrylate, acrylonitrile, methacrylonitrile, divinylbenzene, divinylpyridine, divinyltoluene, diallyl phthalate, ethylene glycol di(meth)acrylate, divinylxylene, divinylethylbenzene, divinylsulfone, divinylketone, divinylsulfide, diallyl maleate, diallyl fumarate, diallyl succinate, diallyl carbonate, diallyl malonate, diallyl oxalate, diallyl adipate, diallyl sebacate, divinyl sebacate, diallyl tartrate, diallyl silicate, triallyl tricarballylate, triallyl aconitate, triallyl citrate, triallyl phosphate, N,N-methylene dimethacrylamide, N,N-methylene dimethacrylamide, N,N-ethylenediacrylamide, trivinylbenzene, and combinations thereof. Additionally, the suitable binder may be in a form of solutions or small-particle size dispersion. Examples of such binders include, but are not limited to, polyacrylic acid; sodium or ammonium polyacrylate; sulfo-polyesters; homopolymers, copolymers, or hybrid systems such as poly urethane/acrylic hybrid latexes; and combinations thereof.

A variety of amine stabilizers may be used in the present disclosure. The amine stabilizer may include one or more amine moieties. The amine moiety may be primary amine (—NH₂), secondary amine (—NHR), tertiary amine (—NR₂), or combinations therefore. The groups on the amine moiety may include, but are not limited to, C1-C20 straight or branched alkane; C2-C20 straight or branched alkene; C2-C20 straight or branched alkyne; C3-C12 cycloalkane; C3-C12 cycloalkene; C3-C12 cycloalkyne; monocyclic aryl ring; bicyclic aryl ring; and combinations thereof. In one embodiment, the groups on the amine moiety may be C1-C6 alkyl or C3-C6 cycloalkyl groups.

When desired, the amine stabilizer may be an amino acid-type stabilizer. In one embodiment of the present disclosure, the water-based barrier coating composition comprises:
(a) a polymeric binder; and
(b) an amino acid-type stabilizer selected from the group consisting of amino acids, amino acid analogs, amino acid mimetics, and combinations thereof, wherein pH of the water-based composition is greater or equal to pKa of the amino acid-type stabilizer.

Suitable amino acid may be neutral amino acids, basic amino acids, acidic amino acids, or combinations thereof. Examples of neutral amino acids include, but are not limited to, glycine, alanine, valine, isoleucine, leucine, phenylalanine, proline, methionine, serine, threonine, tyrosine, tryptophan, asparagine, glutamine, and cysteine. Examples of basic amino acids include, but are not limited to, lysine, arginine, and histidine. Furthermore, the suitable amino acid-based stabilizer may be a synthetic amino acid analogs or amino acid mimetics that function in a manner similar to the naturally occurring amino acids. The term “amino acid analog” refers to a compound that has the same basic chemical structure as a naturally occurring amino acid, except containing some alteration not found in a naturally occurring amino acid (e.g., a modified side chain such as in L-Dopa). The term “amino acid mimetic” refers to chemical compounds that have different structures from the general chemical structure of an amino acid, but functioning in a manner similar to the naturally occurring amino acid. Examples of synthetic amino acid analog and amino acid mimetics include, but are not limited to, aromatic amino acid analogs, aliphatic amino acid analogs, proline analogs, heterocyclic amino acid analogs, phosphorylated amino acids, chiral amino epoxides, unprotected α-amino acid analogs, 3-amino-3-phenylpropionic acid analogs, homoamino acids, 3-amino-4-phenylbutyric acid analogs, and combinations thereof.

The pH of the disclosed water-based barrier coating composition must be equal to or greater than the pKa of the amine stabilizer in order to achieve an unexpected enhanced stability and excellent barrier performance. As used herein, pKa represents the acid dissociation constant, which is generally determined by the formula:

pKa=−log([H⁺][A⁻]/[HA]),

wherein
[H⁺] is the concentration of hydronium ion,
[A⁻] is the concentration of conjugate base, and
[HA] is the concentration of the amine stabilizer.

For amine stabilizers having both carboxy [pKa₁] and amino [pKa₂] functionalities, such as amino acids, the pH of the disclosed water-based barrier coating composition is generally equal to or greater than the pKa₁ value for the amine stabilizer. In one embodiment, the pH of the disclosed water-based barrier coating composition is equal to or greater than an isoelectric point of the amine stabilizer. The isoelectric point is the pH at which a particular molecule carries no net electrical charge. For the amino acids, the isoelectric point is generally calculated as the average of the pKaₛ of the molecule. When the amino acids containing more than two ionizable groups such as lysine, the pKa is the average of the two groups that lose and gain a charge from the neutral form of the amino acid (i.e. in the case of lysine, the two amine pKa values).

When desired, the water-based barrier coating composition of the present disclosure may further include filler particles. The fillers may be the standard low cost filler particles where intercalation may not occur; or the layered particles capable of being at least partially exfoliated or intercalated; or nanoparticle fillers; or combinations thereof. Additionally, the water-based barrier coating composition of the present disclosure may further include an additive. Examples of such additives include, but not limited to, colorants, pigments, defoaming agents, dispersing agents, tackifiers, surfactants, emulsifiers, coalescing agents, plasticizers, buffers, neutralizers, wetting agents, leveling agents, thickeners, rheology modifiers, biocides, waxes, water repellants, slip or mar aids, antioxidants, starch, and combinations thereof.

The water-based barrier coating compositions are suitable for application to a variety of substrates. Examples of such substrates include, but are not limited to, paper stock, paper board, bond paper, cardboard, fiberboard, particle board, recycled materials, wood, consolidated wood products, glass, plastic, metal, ceramics, leather, concrete, gypsum, and stucco. In one embodiment of the present disclosure, the substrate is paper-based products such as paper and paperboard. In one embodiment of the present disclosure, the substrate or article may be a synthetic film such as polyethylene, polypropylene and polyethylene terephthalate.

FIG. 1 shows one embodiment of the disclosed multilayer product, comprising a substrate 10 and a layer of the disclosed water-based barrier coating composition 11 applied on one surface of the substrate 10.

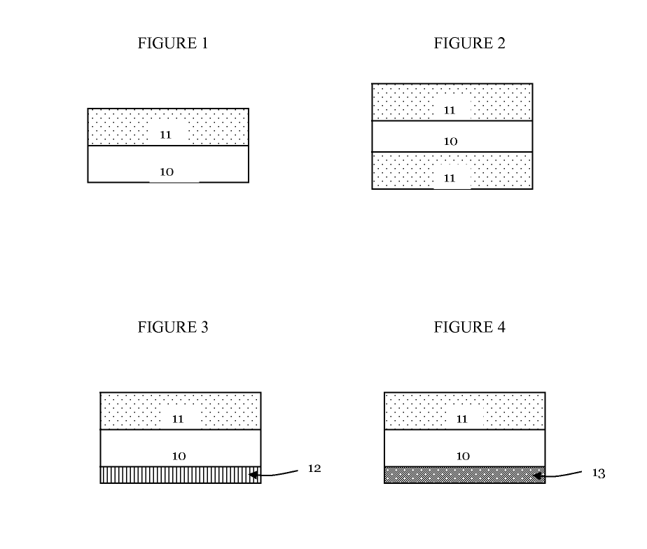

FIG. 2 shows one embodiment of the disclosed multilayer product, comprising a substrate 10 and layers of the disclosed water-based barrier coating composition 11 applied on both surfaces of the substrate 10.

FIG. 3 shows one embodiment of the disclosed multilayer product, comprising a substrate 10, a layer of the disclosed water-based barrier coating composition 11 applied on one surface of the substrate 10, and a sealing layer 12 on the other side of the substrate 10. Examples of suitable materials for use in the sealing layer include, but are not limited to, ethylene vinyl acetate (EVA), ethylene methyl acrylate (EMA), copolymers of EVA and EMA, and combinations of EVA and/or EMA and other polymers or materials. Any known method of sealing process may be used in the present disclosure. These include, but are not limited to, a heated platen, RF energy, ultrasonic energy, and combinations thereof.

FIG. 4 shows one embodiment of the disclosed multilayer product, comprising a substrate 10, a layer of the disclosed water-based barrier coating composition 11 applied on one surface of the substrate 10, and a functional layer 13 on the other side of the substrate 10. The functional layer is to impart or further enhance the selected function onto the paper-based product. Examples of such functions include, but are not limited to, good printability, abrasion resistance, skid resistance, and tear resistance.

FIG. 5 shows one embodiment of the disclosed multilayer product. The substrate 10 is applied on one side with a layer of the disclosed water-based barrier coating composition 11, and subsequently a layer of polymeric film 14 is extruded or laminated onto the barrier coating layer. The polymeric film may be natural or synthetic polymer. Examples of polymeric films suitable for the present disclosure include, but are not limited to, polyolefin such as polyethylene and biaxially oriented polypropylene; polyester such as polyethylene phthalate and biaxially oriented polyester film; polyamide such as nylon and metallocene catalyzed nylon; poly(ethylene-vinyl alcohol); polyvinylidene chloride; polyvinyl alcohol; lactic acid-based polymer; polyvinyl chloride; polyacrylonitrile; and combinations thereof.

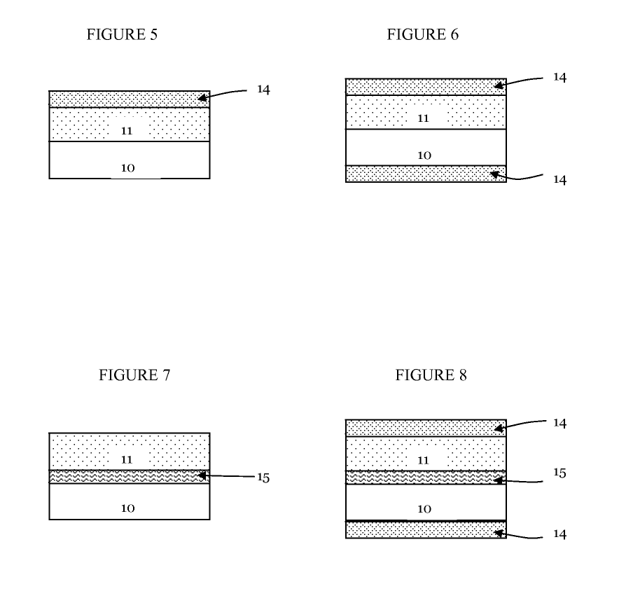

FIG. 6 shows one embodiment of the disclosed multilayer product. The substrate 10 is applied on one side with a layer of the disclosed water-based barrier coating composition 11, and then layers of polymeric films 14 are extruded or laminated onto the both side on both surface of the resulting coated substrate.

FIG. 7 shows one embodiment of the disclosed multilayer product. The substrate 10 is first applied on at least on side with a basecoat 15 to enhance the surface smoothness. Then, a layer of the disclosed water-based barrier coating composition 11 is coated onto the basecoat layer 15.

FIG. 8 shows one embodiment of the disclosed multilayer product, wherein a layer of polymeric film 14 is extruded or laminated onto the both sides of multilayer structure of FIG. 7.

FIGS. 1-8 are only to demonstrate some structural examples for the multilayer product of the present disclosure. It is to be understood that one skill in the art may tailor the structure of multilayer product to provide the desired performance for the selected end use applications, without departing from the concept of present disclosure.

The disclosed coating composition 11 may be applied onto the substrate by any known application methods. These include, but are not limited to, size press application, brushing, spraying, roll coating, rod-coatings, dipping, spreading, printing methods, air knife coating, curtain coating, and extrusion.

The barrier coatings derived from the disclosed coating composition are suitable for application to packaging substrates. These disclosed coatings reduce the gas, vapor or liquid permeability of these coated substrates.

The coated articles, as well as freestanding films produced from the disclosed water-based barrier coating compositions exhibit enhanced barrier performance.

### EXPERIMENTS

In order that the disclosure may be more fully understood, the-following examples are provided. It should be understood that these examples are for illustrative purposes only and are not to be construed as limiting the present disclosure in any way.

### [1] Analytical Methods

The following methods may be used to characterize the various embodiments of the present disclosure and their use as barriers for packaging and other applications.

Oxygen Transmission Rate (OTR)

The oxygen transmission rate (OTR) of the coated and uncoated substrates were measured at 23° C. and 0% RH using Mocon OXTRAN 35 2/20 or 2/60 modules. The samples were loaded onto the modules and conditioned for 2 hours prior to the OTR measurement.

Thickness Measurements

The thickness was calculated based on the weight and assumed density of the coating. The thickness of the coating on a substrate was measured after the OTR was recorded. Each sample was removed from Mocon modules. A circle of specified size was cut from the sample and weighed to obtain the weight of coated circle. The weight of the coating was obtained by subtracting the weight of the uncoated circle from that of the coated circle. Then, thickness of the coating was calculated from the size and the weight of the coating.

Permeability

Permeability was calculated using the following equation:

$$Coating permeability = \frac{Coating Thickness}{( 1 / OTR ) - ( Substrate Thickness / Substrate Permeability )}$$

### [2] Preparation of the Master Filler Dispersion

About 165 g of the selected clay filler was added into a 500 ml stainless steel beaker containing about 135 g of deionized water with rapid stirring using a Cowles high shear disperser. Once the slurry was de-aerated and all of the clay was wet, the mixing speed was increased to obtain maximum mixing and minimum air entrainment. The mixture was ground for one hour.

### [3] Preparation of the Water-Based Barrier Coating Containing Clay Filler

The amino stabilizer and water were added into the Master Filler Dispersion, and the resulting mixture was mixed until the amino stabilizer was dissolved in water. Percent solids and pH of the mixture were adjusted to the selected value, and the mixture was allowed to equilibrate overnight. The polymeric binder was then slowly added into the mixture and continued to stir for one hour to provide the coating formulation. Before testing, the coating formulation was allowed to degas and equilibrate overnight.

### [4] OTR Barrier Performance of the Disclosed Coating Composition

(a) Effect of the Filler and Amine Stabilizer

A corona-treated biaxially oriented polypropylene (BOPP) film was used as a substrate. Modified styrene/butadiene (SBR) latex was used as a polymeric binder in the coating composition. Lysine was used as the amine stabilizer. Two Types of kaolin clay were tested, and their physical propertied were as shown in TABLE 1. Clay #1 had high shape factor of 90 and was typically used in the known water-based oxygen coating compositions. Clay #2 was the standard low-cost clay filler. Two controls were used for the comparison: the BOPP film without any coating and the BOPP film coated with the solely the modified SBR binder.

TABLE 1

| | d50 | BET Surface Area | |
|---|---|---|---|
| Clay | (micron) | (m²/g) | Shape Factor |
| #1 | 1.551 | 12.8 | 90 |
| #2 | 0.175 | 22.9 | 10 |

The water-based coating compositions 2C and 2E containing kaolin filler and lysine stabilizer were prepared by mixing 43% modified SBR, 3.4% lysine, and 53.6% clay (based on dry weight percentage). The coating compositions had a pigment volume concentration of about 0.36. Percent solids of the coating composition were adjusted to about 50%, and the pH was adjusted to about 9.7. The water-based composition 2F containing lysine stabilizer was prepared by mixing 50% modified SBR binder with 5% lysine, and the pH was adjusted to about 9.7.

The water-based coating compositions were drawn down with a #20 wirewound rod onto the BOPP film substrate to provide a coating with a dry-thickness of about 8 microns. The OTR of each coated film was measured using Mocon Ox-Tran 2/21 and compared to those of the two controls. (TABLE 2)

TABLE 2

| Coating | | |
|---|---|---|
| Composition | Coating Composition | OTR |
| No. | (BOPP Film Substrate) | (cc/m² · day · atm) |
| — | No Coating | 1900 |
| 2A | Modified SBR Latex | 615 |
| 2B | Modified SBR Latex + Clay #1 | 610 |
| 2C | Modified SBR Latex + | <1* |
| | Clay #1 + Lysine | |
| 2D | Modified SBR Latex + Clay #2 | 620 |
| 2E | Modified SBR Latex + | <1* |
| | Clay #2 + Lysine | |
| 2F | Modified SBR Latex + Lysine | <1* |

*The detection limit of the Mocon instrument is the OTR value of 1 cc/m² · day · atm

As expected, the coating compositions 2B and 2C showed improved oxygen barrier performance because the exfoliated, layered clay #1 provided a tortuous effect impeding the diffusion of oxygen molecules through the coated substrate. It was, however, unexpected that the coating composition 2E should have provided the same level of oxygen barrier as the coating composition 2C. Clay #2 in the coating composition 2E was standard low-cost clay with low shape factor number. The superior oxygen barrier performance (i.e., low OTR value) of the coating composition 2E to that of the composition 2D indicated that the lysine stabilizer in the coating composition at pH of about 9.7 was critical in enhancing the oxygen barrier performance.

It was further unprecedented that the coating compositions 2F showed similar level of oxygen barrier performance as that of the coating compositions 2B and 2C, since 2F contained no filler particles. The OTR of the coating composition 2A was about 615 cc/m².day.atm; whereas, that of the coating composition 2F was less than 1 cc/m².day.atm. The only difference in the coating composition 2A and 2F was the presence of lysine stabilizer in the in the coating composition at pH of about 9.7. This confirmed that the lysine stabilizer was the critical contributor in enhancing the oxygen barrier performance of the water-based coating composition.

(b) Effect of the pH of the Coating Composition

To confirm that the pH of the coating composition relative to pKa of the amine stabilizer was critical for oxygen barrier performance, and not the mere presence of the amine stabilizer, a series of water-based coating compositions containing lysine stabilizer and having different pH was tested for their oxygen barrier performance. (TABLE 3) Paperboard was used as a substrate. Modified styrene/butadiene (SBR) latex was used as polymeric binder, and Clay #1 was used as filler particles. The coating compositions were adjusted to the selected pH values and allowed to equilibrate overnight before testing.

TABLE 3

| Coating | | pH of the |
|---|---|---|
| Composition | Coating Composition | Coating |
| No. | (Paperboard Substrate) | Compositions |
| — | No Coating | n/a |
| 3A | Modified SBR Latex + Lysine + | 5 |
| | Clay #1 (Acid-washed) | |
| 3B | Modified SBR Latex + Lysine + | 6 |
| | Clay #1 (Acid-washed) | |
| 3C | Modified SBR Latex + Lysine + | 7 |
| | Clay #1 (Acid-washed) | |
| 3D | Modified SBR Latex + Lysine + | 9.5 |
| | Clay #1 (Untreated) | |

TABLE 4

| | pH of the | |
|---|---|---|
| | Coating | OTR |
| Coating Composition No. | Compositions | (cc/m² · day · atm) |
| 1 (No Coatings) | n/a | >10,000 |
| 2 | 5 | 300 |
| 3 | 6 | 240 |
| 4 | 7 | 130 |
| 5 | 9.5 | <1* |

*The detection limit of the Mocon instrument is the OTR value of 1 cc/m² · day · atm

Each coating composition was drawn down onto the paperboard substrate to provide a coating with a dry-thickness of about 12 micron. The OTR of each coated board was measured using Mocon Ox-Tran 2/21 and compared to that of the uncoated board. (TABLE 4)

Lysine has a pKa₁ and pKa₂ of 8 and 10.25, respectively. Therefore, the average pKa of the Lysine is 9.13. As shown in TABLE 4, the OTR of the disclosed coating composition having a pH of about 9.5 had far superior OTR barrier performance to those having the pH lower than the pKa of the lysine. This result was unexpected, since it had been established in prior art that layered fillers in coating compositions must be acid-washed in order to achieve exfoliation, which was demonstrated to be critical for good barrier performance. The water-based barrier coating composition of the present disclosure having a pH greater or equal to the pKa of the amine stabilizer provides excellent barrier performance without the necessity of pretreatment of the layered fillers.

(c) Effect of Different Polymeric Binders

Two additional polymeric binders typically used in the coating industry were investigated as binders in the disclosed water-based coating composition. The resulting coating compositions were applied onto the BOPP film substrate. The oxygen barrier performance of the coated BOPP films was measured and compared to that of the uncoated BOPP film.

TABLE 5

| Coating | | |
|---|---|---|
| Formulation | Coating Formulation | OTR |
| No. | (BOPP Film Substrate) | (cc/m² · day · atm) |
| — | No Coating | 1900 |
| 5A | Styrene-Acrylic Latex | 1800 |
| 5B | Styrene-Acrylic Latex + CMC | 1755 |
| 5C | Styrene-Acrylic Latex + CMC + | <1* |
| | Lysine | |

*The detection limit of the Mocon instrument is the OTR value of 1 cc/m² · day · atm

TABLE 5 showed the comparative oxygen barrier performance of the coated BOPP film when styrene-acrylic emulsion was used as binder in the coating compositions. The coating composition 5C was prepared from 50% styrene-acrylic binder, 0.5% carboxymethyl cellulose (CMC) thickener, and 2.7% lysine stabilizer; and the pH of the composition was adjusted to about 9.7.

TABLE 6 showed the comparative oxygen barrier performance of the coated BOPP film when modified SBR emulsion was used as binder in the coating compositions. The coating composition 6B was prepared from 50% SBR binder, 0.5% carboxymethyl cellulose (CMC) thickener, and 5.0% lysine stabilizer; and the pH of the composition was adjusted to about 9.7.

TABLE 6

| Coating | | |
|---|---|---|
| Formulation | Coating Formulation | OTR |
| No. | (BOPP Film Substrate) | (cc/m² · day · atm) |
| — | No Coating | 1900 |
| 5A | Modified SBR Binder | 615 |
| 5B | Modified SBR Binder + CMC + | <1* |
| | Lysine | |

*The detection limit of the Mocon instrument is the OTR value of 1 cc/m² · day · atm

TABLE 7 showed the comparative oxygen barrier performance of the coated BOPP film when vinyl-acrylic emulsion was used as binder in the coating compositions. The coating composition 7B was prepared from 50% vinyl/acrylic binder, 0.5% carboxymethyl cellulose (CMC) thickener, and 2.7% lysine stabilizer; and the pH of the composition was adjusted to about 9.7.

TABLE 7

| Coating | | |
|---|---|---|
| Formulation | Coating Formulation | OTR |
| No. | (BOPP Film Substrate) | (cc/m² · day · atm) |
| — | No Coating | 1900 |
| 7A | Vinyl-Acrylic Binder | 1700 |
| 7B | Vinyl-Acrylic Binder + CMC + | <1* |
| | Lysine | |

*The detection limit of the Mocon instrument is the OTR value of 1 cc/m² · day · atm

TABLES 5-7 showed that different polymeric binders may be used in the disclosed water-based coating composition to impart excellent oxygen barrier performance to the treated substrate.

(d) Effect of Different Amine Stabilizers

Three types of amino acids were tested as amine stabilizer for the disclosed coating compositions: glycine, lysine, and arginine. The coating compositions were prepared consisting of 50% modified styrene/butadiene (SBR) latex binder, 0.5% CMC thickener, and 7.4% selected amine stabilizer. The pH of each coating composition was adjusted to at least equal to the pKa of the amine stabilizer in that particular composition, and the resulting composition was equilibrated overnight prior to testing. The coating composition containing glycine stabilizer had a pH of about 9.0. The coating composition containing lysine or arginine stabilizer had a pH of about 9.7. (TABLE 8)

TABLE 8

| Coating Formulation | OTR |
|---|---|
| (BOPP Film Substrate) | (cc/m² · day · atm) |
| No Coating | 1900 |
| Modified SBR Binder | 620 |
| Modified SBR Binder + CMC | 400 |
| Modified SBR Binder + CMC + Glycine | <1* |
| Modified SBR Binder + CMC + Lysine | <1* |
| Modified SBR Binder + CMC + Arginine | <1* |

*The detection limit of the Mocon instrument is the OTR value of 1 cc/m² · day · atm

The coating compositions were applied on the corona-treated BOPP film substrate. The oxygen barrier performance of the coated BOPP films was measured and compared to those of two controls: the uncoated BOPP film and the BOPP film coated with the solely the modified SBR binder. The BOPP films coated with the disclosed coating compositions showed excellent oxygen barrier performance when different types of amino acids were used as amine stabilizers, without the necessity of high aspect ratio fillers. The pH of the coating composition was above the pKa of the particular amine stabilizers in that particular coating composition.

(e) Effect of the Coating Thickness

The coating formulation 6B was drawn down on the graphics side of 12 point-paperboard PrintKote SBS (available from MWV Corp.). The first paperboard sample was coated with only one layer of the coating formulation. The second paperboard sample was coated with two layers of the coating formulation, and the third paperboard sample was coated with three layers. The OTR of the coated samples were measured using Mocon Ox-Tran 2/21 and compared to that of the control sample (i.e. uncoated paperboard).

TABLE 9

| No. of Coating Layers | Coat Weight | |
|---|---|---|
| (Paperboard Substrate) | (g/m²) | OTR (cc/m² · day · atm) |
| No Coating | 0 | >10,000 |
| Single | 17.07 | 1,205 |
| Double | 39.45 | 18 |
| Triple | 56.53 | <1* |

*The detection limit of the Mocon instrument is the OTR value of 1 cc/m² · day · atm

As shown in TABLE 9, the paperboard coated with the disclosed water-based coating composition had far superior oxygen barrier performance to the control. Additionally, the oxygen barrier performance improved as the thickness (i.e., number of coating layers) of the coating increased.

### [5] OTR Barrier Performance of the Disclosed Multilayer Substrate

A multilayer substrate of FIG. 5 was prepared. The 18-point cupstock paperboard substrate (Substrate 10) was coated on one side with a water-based coating composition (Layer 11). Subsequently, a layer of low-density polyethylene (Layer 14) was applied at the 1-mil thickness onto the surface of the applied coating layer (Layer 11). The coating composition contained about 44% SBR-based binders, 52% standard deionized kaolin clay, and 4% L-arginine stabilizer (based on dry weight). The coating composition had % solids of about 55% solids and pH of about 9.7.

The multilayer paperboard structures of FIG. 5 were prepared with three different coat weights of the coating composition (layer 11): 8.4 lb, 10.0 lb, and 13 lbs per 3000 ft2 of the paperboard substrate. The oxygen barrier performance of the disclosed multilayer structures was measured and compared to that of untreated paperboard substrate.

TABLE 10

| Coat Weight of the Coating Layer 11 | |
|---|---|
| in the Multilayer Structure of FIG. 5 | OTR |
| (lbs of dry coating/3,000 ft² of paperboard) | (cc/m² · day · atm) |
| Untreated Paperboard | >10,000 |
| 8.4 lb/3,000 ft² | 122.50 |
| 10.0 lb/3,000 ft² | 102.0 |
| 13.0 lb/3,000 ft² | 44.5 |

As shown in TABLE 10, the multilayer structure of FIG. 5 containing a layer of the disclosed water-based coating composition had excellent oxygen barrier performance.

While the invention has been described by reference to various specific embodiments, it should be understood that numerous changes may be made within the spirit and scope of the inventive concepts described. It is intended that the invention not be limited to the described embodiments, but will have full scope defined by the language of the following claims.

1. A water-based barrier coating composition, comprising:
(i) a polymeric binder; and
(ii) an amine stabilizer, wherein pH of the water-based composition is greater than or equal to pKa of the amine stabilizer.

2. The composition of claim 1, further comprising filler particle selected from the group consisting of kaolin clay, talc, calcined clay, structured clay, ground calcium carbonate, precipitated calcium carbonate, titanium dioxide, aluminum trihydrate, satin white, silica, zinc oxide, barium sulfate, and mixtures thereof.

3. (canceled)

4. The coating composition of claim 1, further comprising filler particle that includes layered filler capable of being at least partially exfoliated.

5. (canceled)

6. The composition of claim 1, wherein the polymeric binder comprises a non-elastomeric polymer.

7. The composition of claim 1, wherein the polymeric binder comprises a member selected from the group consisting of polyesters, styrene-acrylic polymers, styrene-butadiene polymers, vinyl-acrylic polymers, polyvinyl acetate, polyurethanes, polyacrylic acid, sodium polyacrylate, ammonium polyacrylate, sulfo-polyesters, urethane/acrylic polymer, and combinations thereof.

8. (canceled)

9. (canceled)

10. (canceled)

11. A barrier coating derived from the composition of claim 1.

12. The composition of claim 1, wherein the amine stabilizer comprises an amino acid-type stabilizer selected from the group consisting of amino acids, amino acid analogs, amino acid mimetics, and combinations thereof.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. A barrier coating derived from the composition of claim 12.

28. A multilayer product, including a substrate and a layer of barrier coating derived from the water-based coating composition of claim 1.

29. The product of claim 28, wherein the amine stabilizer includes an amino acid-type stabilizer selected from the group consisting of amino acids, amino acid analogs, amino acid mimetics, and combinations thereof.

30. The product of claim 28, further including a layer of sealing layer.

31. The product of claim 28, further including a layer of polymeric film on the surface of the layer of barrier coating.

32. The product of claim 31, wherein the polymeric film includes a polymer selected from the group consisting of polyolefin, polyester, polyamide, nylon, polyvinyl alcohol, poly(ethylene-vinyl alcohol), polyvinylidene chloride, polyvinyl chloride, polyacrylonitrile, polyvinylidene chloride, polyvinyl alcohol, lactic acid-based polymer, polyvinyl chloride, polyacrylonitrile, and combinations thereof.

33. (canceled)

34. (canceled)

35. (canceled)

36. (canceled)

37. (canceled)

38. (canceled)

39. A multilayer product, including:
(i) a substrate having the first side and the second side;
(ii) a layer of a first polymeric film on the first side of the substrate;
(iii) a layer of barrier coating, on the second side of the substrate, derived from a water-based coating composition comprising:
(a) a polymeric binder, and
(b) an amine stabilizer, wherein pH of the water-based composition is greater than or equal to pKa of the amine stabilizer; and
(iv) a layer of a second polymeric film applied on the layer of barrier coating (iii).

40. The product of claim 39, wherein the first polymeric film includes a polymer selected from the group consisting of polyolefin, polyester, polyamide, nylon, polyvinyl alcohol, polyethylene-vinyl alcohol), polyvinylidene chloride, polyvinyl chloride, polyacrylonitrile, polyvinylidene chloride, polyvinyl alcohol, lactic acid-based polymer, polyvinyl chloride, polyacrylonitrile, and combinations thereof.

41. The product of claim 39, wherein the second polymeric film includes a polymer selected from the group consisting of polyolefin, polyester, polyamide, nylon, polyvinyl alcohol, poly(ethylene-vinyl alcohol), polyvinylidene chloride, polyvinyl chloride, polyacrylonitrile, polyvinylidene chloride, polyvinyl alcohol, lactic acid-based polymer, polyvinyl chloride, polyacrylonitrile, and combinations thereof.

42. The product of claim 39, wherein the amine stabilizer includes an amino acid-type stabilizer selected from the group consisting of amino acids, amino acid analogs, amino acid mimetics, and combinations thereof.

43. The product of claim 39, wherein the polymeric binder comprises a member selected from the group consisting of polyesters, styrene-acrylic polymers, styrene-butadiene polymers, vinyl-acrylic polymers, polyvinyl acetate, polyurethanes, polyacrylic acid, sodium polyacrylate, ammonium polyacrylate, sulfo-polyesters, urethane/acrylic polymer, and combinations thereof.

44. (canceled)

45. The product of claim 39, wherein the water-based coating composition further comprises filler particle.

46. The product of claim 45, wherein the filler particle comprises a member selected from the group consisting of kaolin clay, talc, calcined clay, structured clay, ground calcium carbonate, precipitated calcium carbonate, titanium dioxide, aluminum trihydrate, satin white, silica, zinc oxide, barium sulfate, and mixtures thereof.

47. (canceled)

48. (canceled)
